(19) United States
(12) Patent Application Publication
(10) Pub. No.: US 2004/0044645 A1
(43) Pub. Date: Mar. 4, 2004

(54) Method for delivering data or code segments to a local computer in a distributed computer network

(76) Inventors: Fabio Palumbo, Rome (IT); Marcovaleno Iannicca, Rome (IT)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/450,240

(22) PCT Filed: Dec. 13, 2000
(86) PCT No.: PCT/IT00/00516

(51) Int. Cl. G06F 7/00

(52) U.S. Cl. 707/1

(57) ABSTRACT

The invention relates to a method for supplying data and/or code segments to a local computer, in a distributed computer network, during loading of a first page of information present on a remote computer belonging to said network and requested by said local computer, said first page including a plurality of sequential commands for a read/execute program resident on said local computer, comprising the steps of:

reading, by said read/execute program, of a linking command present on said first page being loaded, said command not coinciding with the last information contained in the first page;

execution of said linking command by the read/execute program, said command causing momentary interruption of loading of the first page and start of loading of an executable object external to the first page;

execution of said external object containing the data and/or the code segments to be supplied:

during the step of execution of said object, simultaneous loading of the subsequent command/commands or information of said first page.

### FIELD OF INVENTION

The subject of the present invention is a method for supplying data and/or code segments to a local computer in a distributed computer network during loading of a page of information present on a remote computer of the network, when this page is. requested by the local computer.

### STATE OF THE ART

In the last few years, at a world level, there has been an unprecedented development of telematics, i.e., of computer systems distributed over a vast territory which, in order to enable exchange of information or executable code segments, use traditional communication lines.

In particular, there has been a wide diffusion of the so-called Internet network which, having originally been developed as a communication system for university computers through the normal telephone network, has progressively extended, with the addition of local networks to other networks, until it has come to constitute a finely meshed “network of networks” extending throughout the world.

At present, for example by means of connection to an Internet provider, it is possible for a user equipped with a local computer linked to the telephone network, to connect up to Internet to access information physically present on remote computers, even thousands of miles away. The communication protocol used for interaction of a local computer within Internet envisages that the user of the local computer can acquire the information available on the network by simply indicating a logic address which corresponds to a data resource on which the required information is stored. Usually, the information is displayed and reproduced on “pages”, i.e., in virtual containers of finite dimensions, generally having a predetermined format.

In what follows, the term “information” will signify a set of data and/or one or more executable-segment codes that can be transmitted by telematic means, whilst the term “page” will signify any one finite set of information acquired and used by a user. In addition, the term “computer” will be used to define any device capable of processing digital signals, and hence may refer not only to traditional electronic computers but also, to cellphones, for example ones with the new UMTS standard, televisions equipped with processing capability or other domestic digital products that can be connected to a distributed network.

Operatively, when the user intends to connect up to Internet to acquire information, the local computer must establish a telephone connection to the network and. be equipped with a special read/execute program (defined as “browser”) to be able to interact (i.e., request, display, execute or send information) with the network itself. Given the intrinsically sequential character of the telephone connection used and given the method of transmission of information in Internet (which does not envisage the creation of point-to-point transmission channels between user and provider of information), the user, following upon the request for a given page of information, must wait a variable interval of time for the said page to be entirely loaded into the local computer and subsequently displayed or executed. This unused time, known as loading time, depends upon the amount of information to be acquired, the type of telephone connection set up, and the path, which a priori is unknown, that the information must follow to reach the local computer from the remote computer.

In addition, since the pages available in Internet are usually written in a language (HyperText Markup Language—HTML) that envisages the sequentiality of the executable code contained in the page itself and the mixing of executable code with data to be displayed, the browser of the local computer, when the user requests a given page, starts to load into the memory of the computer and execute sequentially the commands contained in the page coming from the remote computer; i.e., the browser, which is an interpreter of HTML loads the first command of the page and executes it, then loads the second command and executes it, and so forth.

Consequently, when an HTML command envisages the storage of a large number of data to be reproduced, for example for displaying high-resolution images on the page, the loading time is particularly long.

However, since HTML display/processing (browser) modern programs can use different windows, i.e., virtual portions of the screen of the local computer, for loading different pages, it is a known technique to exploit the opening of secondary windows in which to display pages having fast loading times, in order to provide, by means of the latter, information to the user whilst he is waiting for a page having long storage times to be loaded into a primary window.

In greater detail, when a user requests the loading in a primary window of a page in HTML format which is particularly burdensome in terms of resources to be transferred from the remote computer, the said page may contain a command that forces the browser to open one or more secondary windows in which to load accessory pages that are not very burdensome—i.e., ones presenting high transfer speeds—and that contain information for the user. Once these accessory pages are loaded, the loading of the page originally requested proceeds.

Even though the user has to wait for loading both of the requested page and of the accessory page/pages, he can usually use the information contained in the secondary windows during the completion of loading of the information onto the requested page. This technique, however, increases, sometime drastically, the loading times of the page requested by the user and, in addition, poses problems of positioning of the various windows which, to be effective, must not be physically superimposed on the screen of the local computer.

Furthermore, since the opening of a new window usually involves its activation, to display the information requested, the user must render the first window opened active, i.e., the one containing the requested page, which is frequently hidden by the secondary windows.

Finally, given the loading and sequential execution of the accessory HTML pages, it is possible to provide the user only with limited information, which is displayed in a static way, i.e., without any possible animation or other multimedia content.

### PURPOSES OF THE INVENTION

The purpose of the present invention is to provide a method for supplying data and/or code segments to a local computer, in a distributed computer network, during the loading of a page of information requested by the local computer, which does not involve an excessive increase in the loading times for loading the requested page and which enables an effective display of the data and/or execution of the code to be obtained.

Another purpose of the present invention is to provide a method that enables, during the interval for loading a requested page, information to be supplied to the user in a format that is particularly simple to understand.

A further purpose of the present invention is that of sending data and/or code segments to the local computer in order to exploit the time for loading the requested page.

### SUMMARY OF INVENTION

These and other purposes are achieved by the method claimed in the first independent claim and in the subsequent dependent claims.

According to the present invention, the method for supplying data and/or code segments to a local computer, in a distributed computer network, during the loading of a first page of information envisages that said first page is present on a remote computer belonging to the network and is requested by the local computer. This first page presents a plurality of sequential commands for a read/execute (browser) program resident on the local computer.

The method comprises the steps of:

reading, by the aforesaid read/execute (browser) program, of a command for linking to an external object, present on said first page being loaded and not coincident with the last information contained on the first page;

execution of the linking command by the read/execute program. This command causes the momentary interruption of loading of the first page and start of loading of an executable object external to the first page;

execution of the external object containing the data and/or the code segments to be supplied; and

during the step of execution of the external object, the simultaneous loading/execution of the subsequent command or commands or information contained on the first page.

According to a preferential aspect of the present invention, the external executable object contains a loading command for at least one second page of information that is displayable/executable by said read/execute program.

According to another aspect of the present invention, the first page requested by the user and the external executable object are displayed in different windows on the screen of the local computer. Furthermore, in the case where the opening of a second page of information is envisaged, said second page is displayed in a further window different from the window displaying the first page and the external object.

In a preferential embodiment, the method according to the invention also envisages that the window for execution of the external object is a full-screen window and is superimposed on the window of the first page. At the end of the execution of said external object, the window of this object is removed from the user screen.

### BRIEF DESCRIPTION OF DRAWINGS

A number of preferential embodiments of the present invention will now be illustrated, by way of non-limiting examples, with the aid of the attached figures, in which:

FIG. 1 is a diagram of a distributed computer network in which the method according to the present invention is used;

FIGS. 2a, 2b and 2c are schematic representations in the time sequence of the user screen when a preferential embodiment of the method according to the present invention is used;

FIGS. 3a, 3b and 3c are schematic representations in time sequence of a further preferential embodiment of the method according to the present invention;

FIG. 4 is a block diagram of the embodiment illustrated in FIGS. 3a-3c of the method according to the present invention; and

FIG. 5 is a time diagram of the processes being executed in a particular embodiment of the method according to the present invention.

### DESCRIPTION OF PREFERRED EMBODIMENTS

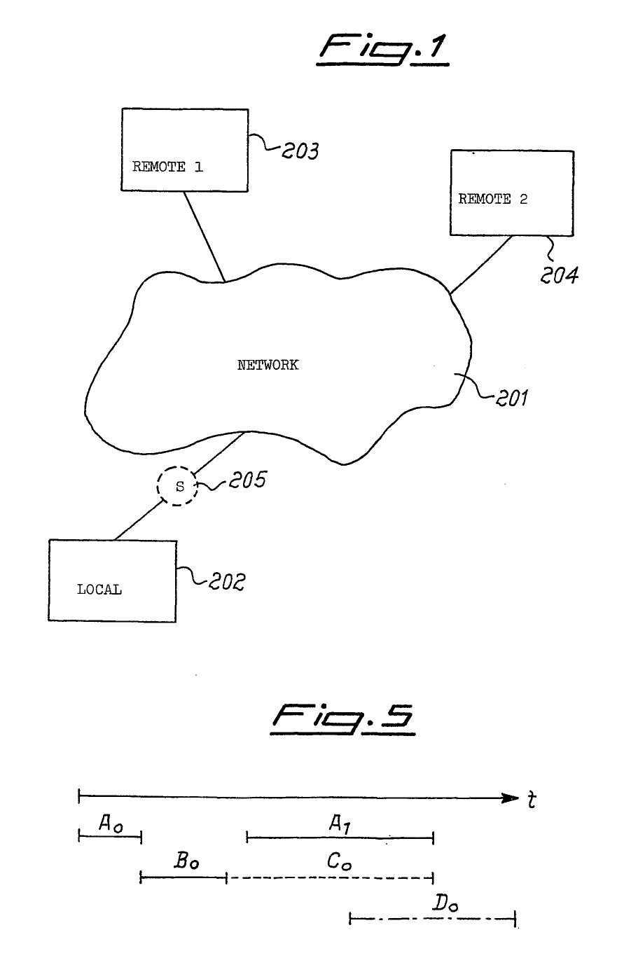

With reference to FIG. 1, the method according to the invention applies to a distributed computer network 201, such as Internet, in which a user of a local computer 202, connected usually by means of a provider 205 to the network 201, requests information present on one or more remote computers 203, 204, the latter remote computers also being connected to the network 201. In a distributed computer network, such as the one represented, each computer connected to the network is identified univocally by a logic address, and the interconnection between two computers for the exchange of information takes place by means of the extemporary creation of a connection path between these computers. In Internet such logic addresses are defined as Universal Resource Locator (URL) addresses and may be permanent or temporary.

In the network represented schematically, the user can request a page of information, i.e., a set of data and/or available code in a pre-defined format (HTML for Internet), from a remote computer (or remote resource) 203 by simply typing into a special program for interaction with the network (browser) the address corresponding to the remote computer on which the requested page is available.

The aforesaid interaction program, which likewise constitutes a program for the display/execution of the contents of the available pages, after the interconnection has been established between the local computer and the remote computer, starts a procedure of sequential loading of the requested page. The sequentiality of the loading and execution is set also by the fact that the physical connection in the network is of a serial type, made by means of telephone systems.

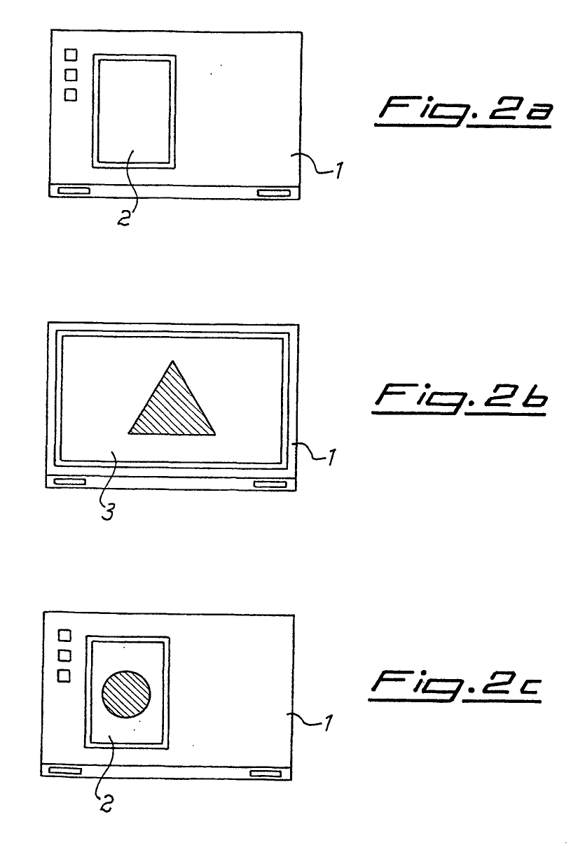

In particular, since the pages available can contain both data and code segments executable by the browser, i.e., commands generally for formatting of the display or for linking to external data, at each loading of a command the latter is executed immediately afterwards. This gives rise to long loading times, above all when the pages requested are burdensome in terms of resources occupied. In a simple implementation of the method according to the present invention, during the loading of a page requested by a browser onto a local computer 202, with reference to FIG. 1 and to FIGS. 2a-2c, it is envisaged that the requested page 2 being loaded on the screen 1 of the local computer 202 from the remote resource 203 (FIG. 2a) will contain, before the last information to be loaded, a linkage command (i.e., a loading and possible execution command) for the linking to an external executable object 3, directed to the browser. The linking command may conveniently be set as the first command contained in the requested page 1.

When the browser finds this command for linking to the external object 3, it momentarily interrupts loading of page 2—i.e., the acquisition of page 1 from the remote computer 203 by means of the network 201—and starts loading of the object 3 containing data and code segments that can be executed either by an external execution program specific for the object 3, for instance recalled by the browser, or by the browser itself.

Page 2, which contains the command for linking to the object 3 may be a page requested directly by the user, by typing in the corresponding address, or may be a page requested from a preceding page being loaded. In the latter case, the preceding page (not illustrated) contains a command for loading of a page of information 2 not directly requested by the user. In turn the aforesaid page 2 will contain, according to the method of the present invention, a command for linking to the external executable object 3.

In certain embodiments of the invention, the object 3 can contain, as initial code, an interpreter program (i.e., a program for the execution), or a linking for the loading and execution of an interpreter program, which is interfaced (via plug-in) with the browser for execution of the remaining code of the object 3. In this case, there is first loading and installation of the interpreter program and subsequently the execution, by the program just installed, of the remaining code lines of the object 3.

Basically at the end of loading of the object 3 there is the start of execution of the object 3 itself (FIG. 2b) and the simultaneous resumption of loading of the information that follows on the aforesaid command for linking to the external object 3, present on the requested page 2. It is likewise possible that start of execution of the object 3 will occur before the end of loading of the said object 3, and that, even so, the prosecution of the operation of loading of the requested page 2 will start only after completion of loading of the object 3.

The execution of the object 3 involves supplying data and/or code segments to the local computer which are directed to the user. The said supply, which is due to the execution of an executable code (the object 3), can be particularly effective and include multimedia content, for example animations, albeit requiring minimal resources for storage (loading) and execution.

In addition, the object 3 can be available indifferently on the same remote computer 203 on which page 1 is present or on a different remote computer 204, which may also be accessed through the network 201.

The simultaneity of the execution of the object 3 and of the prosecution of the loading of page 2 is made possible by the fact that the operating system of the local computer 202 is capable of executing two or more concomitant tasks (multitasking), which consist in the loading of a given file (page 2) and in the execution of a code (the executable object 3) that has already been loaded, whilst, on account of the seriality of the linking to the network 201, it is not able to load two files simultaneously (objects, pages or generically organized sets of data in electronic format).

The time for execution of the object 3 can be set a prori, according to a particular aspect of the present invention, in such a way as to be, on the basis of statistics of loading of page 2, greater than or equal to the total, or residual, loading time, of page 2 and of the object 3 itself.

At the end of execution of the object 3 and hence of the loading of page 2, according to the particular embodiment of the invention so far described, the object 3 closes in order to make room just for page 2, which is now completely loaded (FIG. 2c). Alternatively, the object 3 could also simply make page 2 active at the end of its own execution and remain in background.

In particular, when the method of the present invention is implemented in computers capable of window representation, i.e., capable of displaying the data or the execution of a code in distinct virtual portions of the screen of the computer, it is possible to display the contents of page 2 in a first window and display the contents being executed of the object 3 in a different window. The window of the object 3 can moreover be conveniently superimposed on the window of page 2 and be extended over all the screen of the local computer 202. In this case, at the end of execution of the object 3, the window of page 2 can assume the priority, and/or the window of the object 3 can be eliminated. Alternatively, the execution of the object 3 can take place in the same window, possibly redimensioned, in which subsequently, i.e., at the end of loading, the requested page 2 is displayed.

With reference now to the remaining figures, a preferred embodiment of the method according to the present invention comprises the following steps:

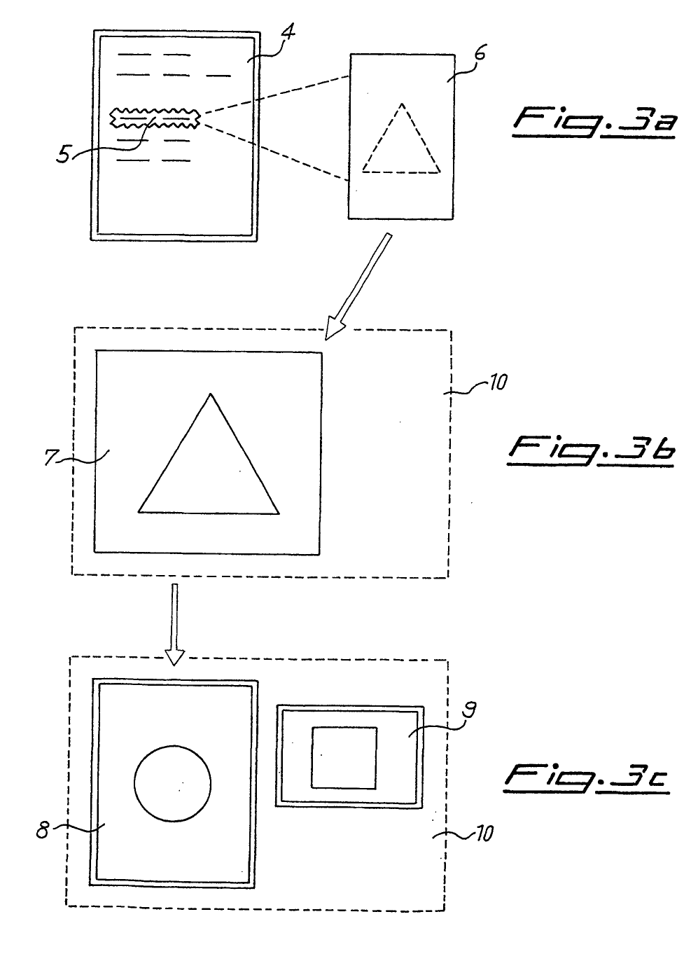

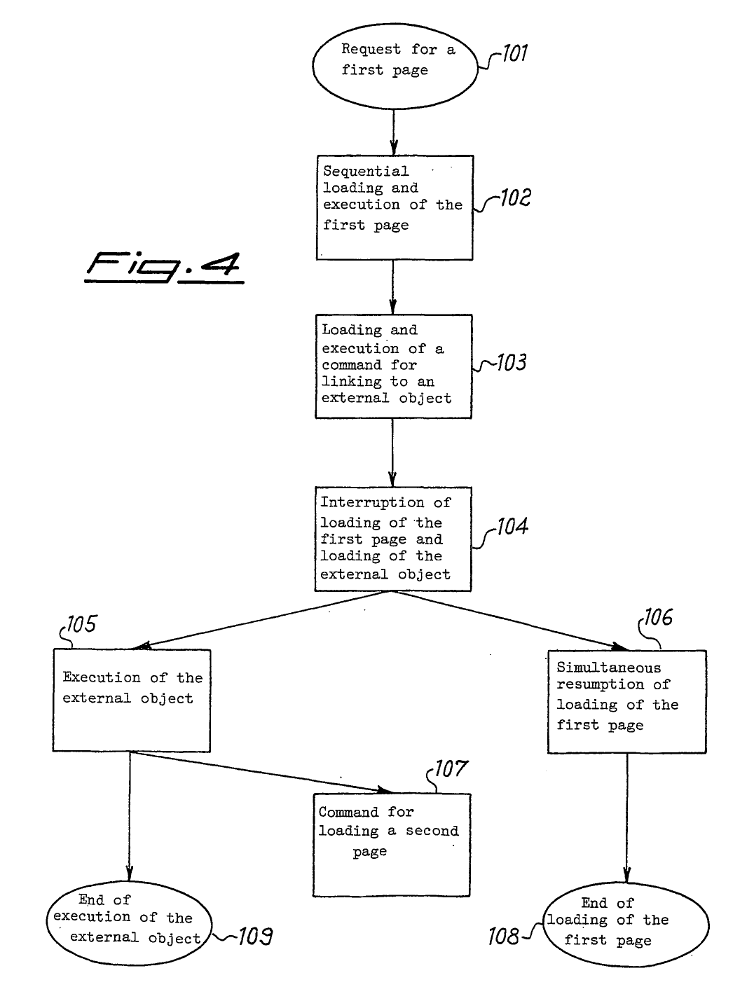

request by a browser of a local computer 202 for a page 4 available on a remote computer 203 reachable by means of a network 201 (step 101 of FIG. 4). The page 4, as represented schematically in FIG. 3a, contains a sequence of commands that may be interpreted by the browser of the local computer 202;

by means of the browser, start of loading and sequential execution of the commands of page 4 (step 102 of FIG. 4). During said step, page 4 may not give rise to any display on the screen 10 of the local computer 202 or may give rise to an incomplete display;

loading and execution, by the browser, of a command 5 for linking to an external executable object 6 that involves the momentary interruption of page 4 and the loading of the object 6 (step 104);

after loading, in this preferential embodiment of the present invention, there take place simultaneously (steps 105, 106) the activity of execution of the object 6, which gives rise to a display of the data and/or of the code contained in the object 6 on the screen 10 within a window 7, and the activity of resumption of loading of page 4 (as illustrated schematically in FIG. 3b). The window 7, for execution of the object 6, is, in this embodiment, superimposed on the display window of page 4;

the code present in the object 6 also comprises a command which, when executed during execution of the object 6 in the window 7, controls loading of a new page, different from page 4 requested by the user (step 107). The command present in the object 6 can be directed to the browser already during execution on the local computer 202, or can be directed to open a new instance of the browser in the operating environment of the local computer 202 with a request for loading, in this new instance, of the new page. In addition, this command for loading the new page, can be present at the end of the executable code of the object 6 or in any other point of the code of the object 6;

at the end of the execution of the object 6 in the window 7 (step 109) there is preferentially the simultaneous completion of the loading of page 4 in a window 8 (step 108). The end of the execution of the object 6 brings about elimination of the window 7;

when also the new page requested by the object 6 is loaded in a window 9, there appears, on the user screen, the situation represented in FIG. 3c.

The page 4, the object 6 and the new page in window 9, transmitted as a files to the local computer 202, can indifferently reside on the same remote computer or on different remote computers (provided that the remote computer or remote computers is/are connected to the network 201), since each linking command, or each loading command, present on page 4 or in the object 6 refers to the logic address corresponding to the remote resource on which said files are available.

In addition, the information contained in the object 6 can be selected and sent to the user on the basis of data, acquired beforehand, regarding the user himself. In this case, for example, the command for linking to the external object 6 can likewise read and send data previously stored on the local computer 202 (for example, in the form of “cookies”) that regard the user that has requested page 4.

FIG. 5 is a time diagram of the processes undergoing execution on the local computer 202 when the particular embodiment of the method according to the present invention, described above and illustrated in FIGS. 3a, 3b, 3c and 4, is executed. In FIG. 5, the straight line designated by t is the time line; the segments designated by A₀, A₁ are graphical representations of the time for loading/execution of page 4; B₀, C₀ are representations, respectively, of the time for loading and the time for execution of the object 6; and D₀ is a representation of the time for loading/execution of the new page loaded in window 9.

In greater detail, after the interval of time A₀, in which there is the loading and execution of the first commands of page 4, the browser finds the command for linking to the external object 6, which, in the particular embodiment illustrated, causes the interruption of loading of page 6 and the loading, for a time interval B_{0.} of the object 6. At the end of loading of the object 6, execution of the latter starts, the said execution lasting for an interval C₀. In an instant, which does not necessarily coincide with the instant of start of execution of the object 6, there is the simultaneous resumption of the loading of page 4. According to this embodiment, at the end of loading of page 4 (after the time interval A₁), there is the simultaneous end of execution of the object 6.

In addition, at any instant whatsoever of the interval of time C₀, there is the execution of the command for loading of a new page contained in the executable code present in the external object 6. In particular, the instant of start of loading of the new page may coincide (in an embodiment not represented) with the instant of start of execution of the external object 6. The loading of the new page occupies a time interval D₀.

Below, with reference to the method represented schematically in FIG. 4 and to the times indicated in FIG. 5, a table summarizing the aforesaid preferential method is given.

TABLE 1

| | | | External | Second | |
|---|---|---|---|---|---|
| | | Requested | object | page | |
| Time interval | Step | page process | process | process | Screen User |
| From 0 to A₀ | Request first | Start read/ | | | Window 8: |
| | page | execute of | | | empty or |
| | | commands of | | | incomplete |
| | | requested | | | |
| | | page | | | |
| A₀ | Read linking | Interrupt | | | Window 8: |
| | command | loading of | | | empty or |
| | | requested | | | incomplete |
| | | page | | | |
| From A₀ to | | | Load | | Window 8: |
| (A₀ + B₀) | | | external | | empty or |
| | | | executable | | incomplete |
| | | | object | | |
| At instants | Execute | Resume | Execute | | Window 8: |
| between | external | loading of | external | | empty or |
| (A₀ + B₀) and | object and | requested | object | | incomplete |
| (A₀ + B₀ + C₀) | simultane- | page | | | Window 7: |
| | ously resume | | | | display of |
| | loading of | | | | execution of |
| | requested | | | | external |
| | page | | | | object |
| At an instant | | | Command | Start | Window 8: |
| between | | | for loading | loading/ | empty or |
| A₀ + B₀) and | | | second page | execution | incomplete |
| (A₀ + B₀ + C₀) | | | | of second | Window 7: |
| | | | | page | display of |
| | | | | | execution of |
| | | | | | external |
| | | | | | object |
| | | | | | Window 9: |
| | | | | | empty or |
| | | | | | incomplete |
| At instant | | End of loading | End of | | Window 8: |
| (A₀ + B₀ + C₀) | | of requested | execution of | | complete |
| equivalent to | | page | external | | Window 7: |
| (A₀ + B₀ + A₁) | | | object | | deleted |
| | | | | | Window 9: |
| | | | | | empty or |
| | | | | | incomplete |
| At instant | | | | End of | Window 8: |
| (A₀ + | | | | loading of | complete |
| B₀ + C₀ + residual | | | | second | Window 9: |
| portion of D₀) | | | | page | complete |

Given in Table 1 above, for each step and time interval, are the operations being executed, which correspond, respectively, to the loading/execution of page 4, to the loading and execution of the executable object 6, and to the loading/execution of the new page in window 9. Table 1 further comprises a column regarding the display on the screen of the local computer 202.

As far as the loading of the new page contained in window 9 is concerned, it should be emphasized that the time of execution of the object 6 (the interval C₀) can be sufficiently long for superimposing itself both on the time interval of residual loading of page 4 (interval A₁), and on the time interval of the new page (interval D₀) in such a way that end of execution of the object 6 (at instant A₀+B₀+C₀ in Table 1) coincides with end of loading both of page 4 and of the new page in window 9.

In addition, the loading command for the new page defined in the method illustrated in FIG. 4 (step 107) can be replaced by one or more loading commands for one or more new pages. In this case, it is still possible, in the programming step, to set a time for execution of the object 6 such as to exploit all the unused times consisting of the time intervals for loading the requested page 4 and the new pages opened subsequently.

The executable object 6 can likewise contain a command for loading a new interactive page, capable of requesting data or commands from the user. In particular, the said interactive page can contain a command, which can be executed by the user, for interrupting execution of the object 6. This new interactive page can be replaced, in alternative embodiments, by commands for the interaction of the user with the system, for example commands for interrupting execution, present in the executable code of the object 6 and available during execution of the latter.

Finally, the page 4 of the method described may be a page directly loaded by the user of the local computer or may be a page requested by a preceding page being loaded (not illustrated) on the local computer. The method can thus originate indifferently from the loading of a new page requested by a user or from the loading of a requested page, by means of the browser, from a page already present on the local computer.

From the above description, it is evident that the method for supplying data and/or code segments to a local computer in a distributed computer network during loading of a first page of information present on a remote computer belonging to said network and requested by the user of said local computer, according to the present invention, makes it possible to furnish additional information effectively to the user, during the time required for loading the requested page.

In addition, with a slight expenditure in terms of loading times (equal to the loading alone of the executable object), there is provided a method for supplying additional information to the user which exploits the unused time for loading the requested page.

### EXAMPLE

In a local computer connected to Internet by means of a normal telephone line with a 38,000-KbPS modem there is loaded a first page in HTML format, which involves an occupation of about 40 KB of storage space. The page, which is loaded and interpreted by a commercially available browser, contains as first command a linking to an external executable file in SWF format, MACROMEDIA® FLASH 5®. Thanks to the prior installation of an appropriate plug-in supplied free by MACROMEDIA®, the browser is able to interpret the SWF code.

In greater detail, the HTML page that is transferred from a remote resource to the browser of the local computer contains a command for “full screen” opening of a window within which the SWF file may be executed after loading. The said window may be the same as the one in which the requested page will be loaded, or else may be a new window.

After loading of the SWF file (which occupies about 10 KB of memory resources), there is the execution of said file in the full-screen window, whilst loading of the HTML page proceeds simultaneously (in background).

In addition, the SWF file contains a command, executed thanks to the MACROMEDIA® plug-in, for opening a second HTML page in a new window of the browser. The said SWF file contains the code segments and the data for a multimedia presentation of the contents of the aforesaid second HTML page comprising animated texts and sounds.

The execution of the SWF file, in the programming step of said file, is calibrated to last as long as the complete loading of the HTML page requested by the user.

At the end of execution of the SWF file, and hence at the end of loading of the HTML page, the second HTML page, recalled from the same SWF file, may still be undergoing loading or may be completely loaded.

1. A method for supplying data and/or code segments to a local computer, in a distributed computer network, during the loading of a first page of information present on a remote computer belonging to said network and requested by said local computer, said first page including a plurality of sequential commands for a read/execute program resident on said local computer, comprising the steps of:
reading, by said read/execute program, of a linking command present in said first page being loaded, said command not coinciding with the last information contained in the first page;
execution of said linking command, by the read/execute program, said command causing the momentary interruption of loading of the first page and start of loading of an executable object external to the first page;
execution of said external object containing the data and/or the code segments to be supplied:
during the step of execution of said object, simultaneous loading of the subsequent command/commands or information of said first page.

2. A method according to any one of the preceding claims, in which said external object contains at least one loading command for at least one second page of information displayable and/or executable by said read/execute program.

3. A method according to claim 2, in which said loading command for at least one second page is executed by said read/execute program only after loading of said first page.

4. A method according to claim 2, in which said loading command for at least one second page is executed by said read/execute program simultaneously with said step of simultaneous loading of the subsequent command/commands of said first page.

5. A method according to any one of the preceding claims, in which execution of said external object terminates not before end of loading of said first page.

6. A method according to any one of the preceding claims, in which said external object is executed by said read/execute program.

7. A method according to any one of claims from 1 to 5, in which said external object is executed by a processing program different from said read/execute program and operating in a concurrent way with respect to said read/execute program.

8. A method according to any one of the preceding claims, in which said external object contains an interpreter for its execution.

9. A method according to any one of claims from 1 to 7, in which said external object contains a loading and execution command of an interpreter for its own subsequent execution.

10. A method according to any one of the preceding claims in which, on the screen of said local computer, said first page and said external object are displayed in different windows.

11. A method according to claim 10, in which the window for execution of said external object is superimposed on the window of said first page, at the end of execution of said external object, the window of said object being removed from the screen.

12. A method according to claim 10 or 11, in which said window of the external object occupies the entire screen of the local computer.

13. A method according to claim 2, 3 or 4, in which said second page is displayed within a window different from the display window of said first page and/or of said external object.

14. A method according to any one of the preceding claims in which said linking command is the first command of said first page.

15. A method according to any one of the preceding claims, in which said external object is present on a remote computer coincident with or different from the remote computer on which said first page is present.

16. A method according to any one of the preceding claims in combination with claim 6, in which said second page is present on a remote computer coincident with or different from the remote computer on which said first page is present.

17. A method according to any one of the preceding claims, characterized in that said step of execution of the external object starts after completion of loading of said external object.

18. A method according to any one of claims from 1 to 16, characterized in that said step of execution of the external object starts before complete loading of said external object, and in that said step of simultaneous loading of the subsequent command or commands of said first page starts, during execution of said external object, after complete loading of said external object.
